(19) United States
(12) Patent Application Publication
(10) Pub. No.: US 2007/0281813 A1
(43) Pub. Date: Dec. 6, 2007

(54) Tension and vibration damping arrangement for a belt drive and a process for operating such an arrangement

(75) Inventor: Sergej Schwarz, Nurnberg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/740,969

(22) Filed: Apr. 27, 2007

(30) Foreign Application Priority Data
Apr. 28, 2006 (DE) 102006019879.4

(51) Int. Cl. F16H 7/08

(52) U.S. Cl. 474/133

(57) ABSTRACT

A tensioning and vibration-damping device for a belt drive is provided, including means (1) for conveying rotary motion in the form of an endless chain or an endless belt and with a tension-roller carrier (2) that can pivot on a support component (3) with tension roller (5), wherein for ensuring a constant tension of the means for conveying rotary motion, the tension roller (5) can be brought into active connection with the means (1) for conveying rotary motion and the tension-roller carrier (2) together with the tension roller (5) can be loaded via a piezoelectric structure (6) with a determined pre-tensioning force against the means (1) for conveying rotary motion. In order to realize effective vibration damping of the means (1) for conveying rotary motion with minimized expense, the invention provides that at least one vibration sensor (7) connected to an electronic controller and regulator (8) is provided, whose sensor signals can be used by the controller and regulator (8) for actuation control of the piezoelectric structure (6), such that vibrations of the means (1) for conveying rotary motion are damped.

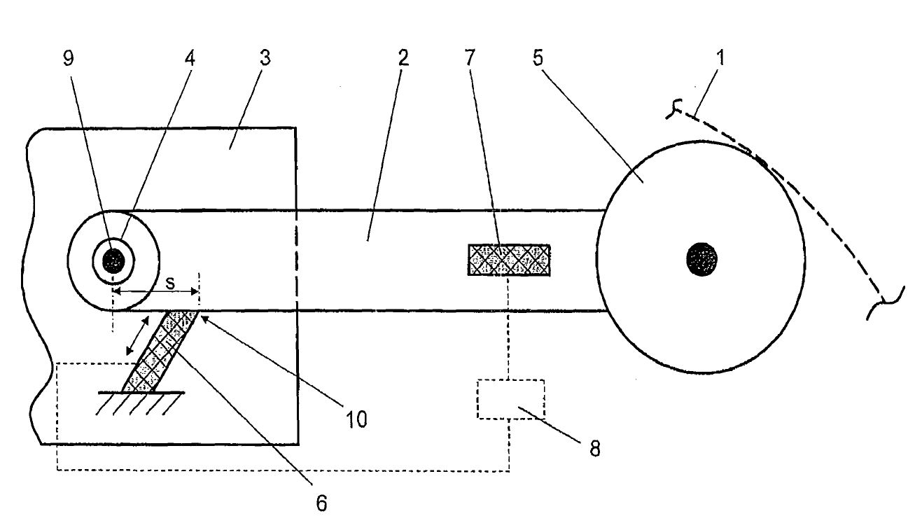

### FIELD OF THE INVENTION

The invention relates to a tensioning and vibration damping device for a belt drive, comprising means for conveying rotary motion in the form of an endless chain or an endless belt and comprising a tension-roller carrier with a tension roller, wherein for guaranteeing a constant tension on the means for conveying rotary motion, the tension roller can be brought into active connection with the means for conveying rotary motion and the tension-roller carrier together with the tension roller can be loaded via a piezoelectric structure with a certain pre-tensioning force against the means for conveying rotary motion.

### BACKGROUND OF THE INVENTION

Tensioning and vibration-damping systems for drives conveying rotary motion, such as, for example, chain or belt drives in motor vehicle engines or other systems, have been known for a long time in a wide variety of constructions.

For example, DE 92 18 566 U1 describes a mechanical belt or chain tensioner with a stationary base part, which has a sleeve, over which a pivoting tension part is guided, wherein a spring tensioning both parts and rotating relative to these parts is inserted between the base part and the tension part. For damping high-frequency correcting movements of the tension part, it is provided that a friction disk loaded exclusively by an axial force is locked in rotation with the tension part and contacts the base part via a friction lining. In this way, the vibration damping is realized essentially by converting motion energy into heat due to the friction between the friction disk and the friction lining.

In addition, for damping high-frequency correcting movements of a tension roller or the lever arm carrying this roller, a relatively complicated belt tensioner is known from WO 02/29281 A1 with friction damping, which has a tension roller supported so that it can rotate with a tensioner frame pivoting on a fixed part. A damper arm similarly pivoting on the fixed part has a so-called damper shoe, which, on its side, is in active connection with a damper running path of the tensioner frame. Finally, a pre-tensioning spring is provided, which is supported on one end on the pivoting tensioner frame and on the other end on the damper arm. If high-frequency correcting movements of the tension roller are registered, this leads to relative movements between the damper shoe and the damper running path, which shall lead, in turn, to damping of the correcting movements of the tension roller or the tensioner frame.

Existing mechanical chain or belt tensioners have in common that the vibration damping is performed merely passively, wherein the damping force is proportional to the frictional coefficient on the friction lining. In addition, the damping force is dependent on the displacement speed and vibrational frequency of the tension part or lever arm and also on the temperature. The vibration amplitudes here comprise orders of magnitudes of a few millimeters. Furthermore, stick-slip effects, which can lead to jerky movements and the generation of noise in the tension lever, are not excluded in such tensioners. Due to the inescapable wear on the friction elements, the service life of the tensioner is limited. Finally, such a tensioner requires increased installation space.

In contrast, hydraulic belt tensioners are also known from practice, wherein the belt is pre-tensioned mechanically by means of a spring, but the vibration damping is performed such that hydraulic oil is pumped through a narrow gap and as a result mechanical vibrational energy is converted into heat. Here, the vibration damping is also performed merely passively, wherein the damping force is dependent on speed, temperature, and frequency. Furthermore, it requires a certain installation position of the tensioner within the system to avoid an outflow of hydraulic oil. This technical solution also involves an increased requirement of installation space.

Finally, from DE 199 59 521 A1, a dynamically controllable guiding and tensioning device for endless drives, such as a control drive in an internal combustion engine, and also a method for its operation are known. There, essentially a dynamically controllable actuator in the form of a piezoelectric actuator is proposed, with whose help a rail-shaped tensioning element can be displaced relative to the tension means of the endless drive. The actuator is controlled as a function of operating parameters of the internal combustion engine.

### OBJECT OF THE INVENTION

The invention is based on the objective of creating a further improved tensioning and vibration-damping device for a belt drive, which allows even more effective vibration damping than before with respect to the state of the art described above for minimal expense. Another object of the invention is specifying a suitable method for operating such a device.

### SUMMARY OF THE INVENTION

According to the features of the main claim, the invention relates to a tensioning and vibration-damping device for a belt drive, with means for conveying rotary motion in the form of an endless chain or an endless belt and with a tension-roller carrier that can pivot on a support component with a tension roller, wherein, for guaranteeing a constant tension of the means for conveying rotary motion, the tension roller can be brought into active connection with the means for conveying rotary motion and the tension-roller carrier together with the tension roller can be loaded via a piezoelectric structure with a determined pre-tensioning force against the means for conveying rotary motion. This device is provided for meeting the stated objective in that there is at least one vibration sensor, which is connected to an electronic controller and regulator and whose sensor signals can be used by the controller and regulator for actuating the piezoelectric structure, such that vibrations in the means for conveying rotary motion are damped.

Instead of the operating parameters of the internal combustion engine, as proposed in the state of the art, now only the vibrations that are generated directly by the belt drive and that are detected by an associated sensor are taken into consideration for the vibration damping. Complicated calculations that are susceptible to errors for an associated controller and regulator are therefore no longer necessary.

The subordinate claims describe preferred improvements or constructions of the invention.

Thus it is provided, for example, that the one or more vibration sensors are arranged on the tension-roller carrier or integrated into the piezoelectric structure. This allows a direct measurement of the vibrations acting in the belt drive, so to speak, at the scene of the events.

The piezoelectric structure is preferably formed by a piezoelectric linear actuator or by a piezoelectric stack composed of several piezoelectric linear actuators. This can generate relatively large adjustment forces within a very short time.

In addition, it has been judged to be advantageous when the piezoelectric structure is supported on one end on a support component, for example, on a crankcase, and on the other end on the tension-roller carrier.

Here, a distance “s” between the rotational axis of the tension-roller carrier that can pivot on the support component and the frictional contact point of the piezoelectric on the tension-roller carrier as a function of the maximum possible travel of the piezoelectric structure and the maximum necessary travel of the tension roller of the tension-roller carrier is kept as small as possible. Therefore, for example, installation space can be saved.

According to another improvement, it is provided that the piezoelectric structure is arranged in series with a tension element that can be actuated mechanically or hydraulically. Therefore, short-frequency vibrations can be optimally damped by the very quickly reacting piezoelectric actuator and long-frequency vibrations can be sufficiently damped by the tension element that can be actuated mechanically or hydraulically.

The invention also relates to a method for operating a tensioning and vibration-damping device for a belt drive according to at least a few of the previously mentioned device features. According to this method, it is provided that the piezoelectric structure is controlled for actuation by the controller and regulator as a function of vibrations of the means for conveying rotary motion or the tension-roller carrier caused by the operation of the belt drive and detected by the vibration sensor such that these vibrations are damped.

In addition, according to the method it can be provided that the detected vibrations are used for detecting the current wear state of the belt drive.

### BRIEF DESCRIPTION OF THE DRAWINGS

The invention is explained in more detail below with reference to an enclosed drawing. The sole figure shows very schematically a tensioning and vibration-damping device constructed according to the invention for a belt drive.

### DETAILED DESCRIPTION OF THE DRAWING

The tensioning and vibration-damping device for a belt drive with means 1 for conveying rotary motion, which can be an endless chain or an endless belt, essentially comprises a tension-roller carrier 2, which can pivot in this case on one end in a slide bushing 4 connected rigidly to a support component 3 and which, on the other end, supports a rotating tension roller 5.

The support component 3 can be formed, for example, by a base plate that can be fixed to a support chassis component of a motor vehicle, by the mentioned chassis component itself, by a crankcase or transmission gearbox, or by any other suitable support component. For guaranteeing a constant tension of the means 1 for conveying rotary motion, the tension roller 5 is brought into active connection with the means 1 for conveying rotary motion, in that the tension-roller carrier 2 together with the tension roller 5 is pressed with a certain pre-tensioning force against the means 1 for conveying rotary motion. For applying the force, in the present case a known piezoelectric structure 6 is provided, which is supported on one end on the support component 3 and on the other end on the tension-roller carrier 2.

Piezoelectric structures 6 or piezoelectric actuators, for example, in the form of piezoelectric ceramics, are suitable for this purpose and are deformed by an electric voltage. Accordingly, they allow extremely precise movements that are associated, incidentally, with very high forces to be generated through deformation, when a voltage is applied.

In the present case, the piezoelectric structure 6 is formed by a known piezoelectric linear actuator. It is also possible, however, and recognized accordingly by the invention to use a piezoelectric stack composed of several piezoelectric linear actuators connected in series as a function of the desired travel of the piezoelectric structure 6.

Due to the recognition that a piezoelectric structure 6 or a piezoelectric actuator can be lengthened or shortened by approximately 1% of its overall length through the application of a voltage, the desired number of piezoelectric actuators to be combined to form a piezoelectric stack can be determined relatively easily.

As the sole figure further shows, there is at least one vibration sensor 7, which is connected electrically via a control and regulation circuit with an electronic controller and regulator 8 to the piezoelectric structure 6 for triggering this structure. The power supply for the piezoelectric structure 6 and for the vibration sensor 7 can be realized here externally via, for example, the onboard network of a motor vehicle.

Likewise, the vibration sensor 7 can also be connected wirelessly to the controller and regulator 8, for example, by radio (not shown in more detail). In this case, in particular, an electrical accumulator allocated directly to the vibration sensor 7 is provided.

As a function of the vibrations generated in the belt drive by the operation of this belt drive and detected by the at least one vibration sensor 7, a force for compensating or damping these vibrations can be generated by the piezoelectric structure 6 and guided via the tension-roller carrier 2 and the tension roller 5 to the means 1 for conveying rotary motion, as a result of which vibration damping can be realized by the piezoelectric structure 6 for a suitably selected frequency and amplitude of the force action.

Here, it does not involve passive damping of the vibrations as in conventional friction or hydraulic systems, but instead active damping, such that the piezoelectric structure 6, in the form of an actuator or a stack of actuators, can be controlled actively against vibration so that no disruptive vibrations with greater amplitude are produced. Thus, for example, known “fluttering” of the means 1 for conveying rotary motion, e.g., a belt, is prevented. Smooth running and special protection of the means 1 for conveying rotary motion are the result.

The damping effect by the device according to the invention can be adjusted independent of external parameters such as temperature and speed of the means for conveying rotary motion. Because the vibration amplitudes of the tension-roller carrier 2 can be held to a very low level, the slide bushing 4 wears to a much lower degree than in conventional devices. Detectable sagging of the belt, in particular, which currently is a limiting factor in many cases for the service life of the means for conveying rotary motion, can be reduced very strongly.

Also, with respect to conventional friction linings for damping vibrations, disadvantageous stick-slip effects positioned there are, in principle, prevented.

The vibration sensor 7 is arranged in the present case directly on the tension-roller carrier 2. Certainly other components of the belt drive can also be used for fixing the vibration sensor 7 if these are excited to vibrate by the operation of the belt drive.

Thus, the one or more vibration sensors 7 can also be constructed as a piezoelectric structure, for example, as a vibration sensor 7 with a seismic mass and can be integrated on the mentioned tension-roller carrier 2 or another vibrating component of the belt drive or also in the optionally used piezoelectric stack.

It is further possible that a piezoelectric actuator (linear actuator) is constructed so that this actuator functions both as an actuator and also as a vibration sensor.

Also, a piezoelectric structure 6, whether it is an actuator and/or a vibration sensor, can be constructed to be self powered with respect to the necessary power supply, in that an electric voltage, which can be made available, in turn, to other piezoelectric actuators or vibration sensors, is generated, for example, through the deformation of the piezoelectric ceramics due to the vibrational excitation of these ceramics.

As is to be further taken from the sole figure, based on the above properties of the piezoelectric structure 6 in the form of a single linear actuator or a piezoelectric stack, this structure can be arranged very close to the rotational axis 9 of the tension-roller carrier 2 that can pivot on the support component 3, whereby savings in installation space are to be noted.

The distance “s” between the rotational axis 9 of the tension-roller carrier 2 and the frictional contact point 10 of the piezoelectric structure 6 on the tension-roller carrier 2 thus can be minimized as a function of the maximum possible travel of the piezoelectric structure 6 and the maximum necessary travel of the tension roller 5 of the tension-roller carrier 2.

As was already explained farther above, the invention is not limited to chain drives, which conventionally require relatively small correcting movements or travels of the allocated tension elements, but instead also comprises belt drives, in which the correcting movements can be increased proportionally.

In order also to be able to effectively implement such correcting movements in the sense of the invention, it can be specified to arrange the piezoelectric structure 6 in the form of one or more actuators combined to form a piezoelectric stack in series with a conventional tensioning element that can be actuated mechanically or hydraulically not shown in more detail. This means that, as an example, a spring-loaded linear tensioner is combined with a piezoelectric structure 6 or with a piezoelectric actuator or a piezoelectric stack, whereby large correcting paths are implemented by the mentioned linear tensioner that can be actuated mechanically or hydraulically, while the damping of the vibrations in question is performed essentially by means of the piezoelectric structure 6.

Finally, there is also the possibility of using the measurement signals prepared by the vibration sensor 7 for detecting the current wear state of the belt drive, in that a comparison of these measurement signals is performed against reference values that are stored, for example, in an electronic memory of the controller and regulator 8.

### REFERENCE SYMBOLS

1 Means for conveying rotary motion
2 Tension-roller carrier
3 Support component
4 Slide bushing
5 Tension roller
6 Piezoelectric structure
7 Vibration sensor
8 Controller and regulator
9 Rotational axis (tension-roller carrier)
10 Frictional contact point (piezoelectric structure 6/tension-roller carrier 2)

1. Tensioning and vibration-damping device for a chain or belt drive, comprising an endless chain or an endless belt for conveying rotary motion and a tension-roller carrier that can pivot on a support component with a tension roller, wherein for providing a constant tension of the endless chain or belt for conveying rotary motion, the tension roller can be brought into active connection with the endless chain or belt for conveying rotary motion, and the tension-roller carrier together with the tension roller can be loaded via a piezoelectric structure with a certain pre-tensioning force against the endless chain or belt for conveying rotary motion, at least one vibration sensor connected to an electronic controller and regulator is provided, which generates sensor signals that are used by the controller and regulator for actuating the piezoelectric structure, such that vibrations of the endless chain or belt for conveying rotary motion are damped.

2. Tensioning and damping device according to claim 1, wherein the at least one vibration sensor is arranged on the tension-roller carrier or integrated into the piezoelectric structure.

3. Tensioning and vibration-damping device according to claim 1, wherein the piezoelectric structure is formed by a piezoelectric linear actuator or by a piezoelectric stack comprised of several piezoelectric linear actuators.

4. Tensioning and vibration-damping device according to claim 1, wherein the piezoelectric structure is supported on one end on a support component and on an other end on the tension-roller carrier.

5. Tensioning and vibration-damping device according to claim 4, wherein a distance “s” between a rotational axis of the tension-roller carrier that can pivot on the support component and a frictional contact point of the piezoelectric structure on the tension-roller carrier is minimized as a function of a maximum possible travel of the piezoelectric structure and a maximum necessary travel of the tension roller of the tension-roller carrier.

6. Tensioning and vibration-damping device according to claim 1, wherein the piezoelectric structure is arranged in series with a tension element that can be actuated mechanically or hydraulically.

7. Method for operating a tensioning and vibration-damping device for a belt chain or drive comprising actuating a piezoelectric structure that acts on a tension-roller carrier and a tension roller using a controller and regulator as a function of vibrations of an endless chain or belt for conveying rotary motion or the tension-roller carrier generated by operation of the chain or belt drive and detected by the vibration sensor, and damping the vibrations.

8. Method according to claim 7, further comprising using the detected vibrations for detecting a current wear state of the belt drive.
